(19) United States
(12) Patent Application Publication
(10) Pub. No.: US 2023/0160436 A1
(43) Pub. Date: May 25, 2023

(54) TRIPOD JOINT AND MANUFACTURING METHOD

(71) Applicant: AKTIEBOLAGET SKF, GOTEBORG (SE)

(72) Inventors: Lisa Angelika BAIERL, Schweinfurt (DE); Tom SCHMITZ, Hambach (DE); Klaus Dietmar RIPPSTEIN, Ebelsbach (DE)

(21) Appl. No.: 17/971,952

(22) Filed: Oct. 24, 2022

(30) Foreign Application Priority Data
Nov. 24, 2021 (DE) 102021213242.1

(51) Int. Cl. F16D 3/205

(52) U.S. Cl. CPC F16D 3/2055; F16D 2200/003; F16D 2200/0021; F16D 2200/0082

(57) ABSTRACT

A tripod joint includes a multi-part pot having an interior and a plurality of raceways for supporting a plurality of rollers in the interior. The pot includes a housing having an open end and a base at the end of the housing opposite the open end, and the base may be formed separately from the housing or one-piece therewith. The raceways may be formed by inserts mounted in the interior which inserts may have a hardness greater than a hardness of the material of the housing.

### CROSS-REFERENCE

This application claims priority to German Patent Application No. 10 2021 213 242.1 filed on Nov. 24, 2021, the contents of which are fully incorporated herein by reference.

### TECHNOLOGICAL FIELD

The present disclosure is directed to a tripod joint with a multi-piece pot that has raceways for supporting rollers, and in particular to a tripod joint having a shaft connected to the multipiece pot.

### BACKGROUND

Drive shafts are used in vehicles to transmit torque from a transmission to wheels, wherein they simultaneously compensate for mechanical movements of the wheel. In order to support such a compensating, tripod joints can be used. Tripod joints include a pot in a tulip shape, in which three raceways for three elements, in particular rollers, are disposed in the pot. Such rollers are attached to a journal, and the journal is attached to the shaft. The rollers allow an axial movement inside the pot and transmit the torque that is received via the shaft. In currently known tripod joints, the tulip or the pot, including the raceways and the shaft, is manufactured monolithically. This causes the manufacturing to be complex and expensive since on the one hand a high-quality steel must be used that is also suitable for the raceways, and on the other hand a heat treatment must be carried on the entire pot in order to generate hardened and therefore stable raceways. This manufacturing also requires special and expensive tools.

### SUMMARY

It is therefore an aspect of the present disclosure to provide a tripod joint that is simple and cost-effective to manufacture and that simultaneously fulfills the requirements on such a tripod joint with respect to durability and stability.

The disclosed tripod joint includes a pot and in particular a shaft connected to the pot. Raceways for the rolling of rollers are provided in the pot.

In particular, at least on the inner-circumferential surface, the pot has a tulip shape that provides internal pockets. These internal pockets each include an inner raceway on which a roller of the journal can respectively roll for transmitting torque and for compensating for mechanical movements, as is explained above. The pockets extend in an axial direction and are circumferentially spaced. The raceways extend axially as well to support axial movement of the rollers in the pot interior.

In contrast to the tripod joints used to date, in order to now allow for a simple and more cost-effective manufacturing, the pot of the tripod joint is configured multi-part. This multi-part nature allows the individual parts of the tripod joint to be manufactured separately, which simplifies the manufacture and makes it possible to exchange individual parts. Depending on the type of the multi-part nature, more cost-effective materials and manufacturing types of the individual parts can also be possible as is explained in more detail below.

According to one embodiment, the pot of the tripod joint comprises a housing part and a base manufactured separately from the housing part and connected to the housing part. In this way the housing part can be manufactured, for example, from a cylindrical blank, and the base, in particular with a shaft integrally connected thereto, can be manufactured separately. When connecting the housing part to the base, it is only necessary that the housing part and the base have a common axis in order to prevent a radial run-out of the shaft that is connected to the base. A further orienting, in particular of the outer circumference of the housing part and of the base, is not required.

The two parts can be connected to each other by welding, for example, friction welding. The base can also be connected to the housing part by pressing-in, shrinking-on, adhering, or clamping.

The housing part includes the raceways for the rollers. In particular, the raceways can be disposed in the pockets of the housing part. The raceways are preferably hardened in order to reduce wear on the raceways. For example, the entire housing part can be made of steel and hardened as a whole.

Alternatively to a separate manufacturing of the base and of the housing part, or also in combination therewith, the housing part can include separate inserts that form the raceways for the rollers. Also in this case the pot is comprised of a plurality of parts, namely the housing part and the inserts for the raceways, which are manufactured individually and subsequently assembled.

According to this embodiment, the raceways are configured as separate raceway elements in the form of inserts that are inserted into the pockets of the housing part. The inserts can be connected to the housing part in various ways, by a clamping, such as, for example, a flanging. Other types of connections, such as welding, adhering, or the like are also possible. Since the inserts are configured as separate elements, they can easily be exchanged if the raceways wear. This increases the total service life of the tripod joint.

The inserts can be attached radially in the housing part. For example, the inserts are configured such that they include at least one section that represents a raceway for a roller. The inserts can also each include two wing sections and a connecting section between these wing sections. The wing sections can then each be disposed in a different pocket and form the raceways for the rollers. Alternatively the inserts can also be C-shaped and each be disposed in one pocket.

Each of the inserts can be formed from a material that is harder than the material of the housing part. For example, the inserts can be formed from steel, in particular a hardened seamlessly extruded steel, or from another hard material, for example, ceramic.

In contrast thereto, the housing part can be formed from an aluminum alloy, for example, a high-strength aluminum alloy, such as AW5083. The housing part can be manufactured as an extruded element, which makes possible a more cost-effective manufacturing in comparison to a tripod joint forged as a whole as has been required to date. Furthermore, manufacturing the housing part as an extruded element has the advantage that no separate forging tool is required for different length housings. Extruding also allows a precise manufacturing of the profile, and the length can be determined by simple crosscutting. Furthermore, any desired rotationally symmetric contour of the extruded material is possible.

The base can be comprised of a material similar to the housing part, such as, for example, an aluminum alloy, but also a different material.

According to a further aspect, a method is proposed for manufacturing a tripod joint as described above.

Features and embodiments that have been described above with respect to the tripod joint also correspondingly apply for the manufacturing method.

As already explained, the pot of the tripod joint is configured multi-part. Depending on the embodiment, the manufacturing method therefore comprises connecting the respective parts of the pot as is already explained above.

For example, the manufacturing method first comprises a separate manufacturing of the base, in particular integrally with the shaft, and of the housing part. The manufacturing method subsequently comprises a connecting of the base to the housing part, for example by friction welding.

Alternatively, or also in combination therewith, the manufacturing method comprises a separate manufacturing of the housing part and of the inserts and a subsequent insertion of the inserts into the housing part, as well as connecting the inserts to the housing part, for example by flanging.

Further advantages and advantageous embodiments are specified in the description, the drawings, and the claims. Here in particular the combinations of features specified in the description and in the drawings are purely exemplary so that the features can also be present individually or combined in other ways.

In the following the invention is described in more detail using the exemplary embodiments depicted in the drawings. Here the exemplary embodiments and the combinations shown in the exemplary embodiments are purely exemplary and are not intended to define the scope of the invention. This scope is defined solely by the pending claims.

### BRIEF DESCRIPTION OF THE DRAWINGS

FIG. 1 is a front perspective view of a tripod joint according to an embodiment of the present disclosure.

FIG. 2 is a rear perspective view of the tripod joint of FIG. 1.

FIG. 3 is a perspective view of the tripod joint of FIGS. 1 and 2 with rollers omitted for illustration purposes.

FIG. 4 is a partial perspective view of the housing part of the tripod joint of FIGS. 1-3.

### DETAILED DESCRIPTION

In the following, identical or functionally equivalent elements are designated by the same reference numbers.

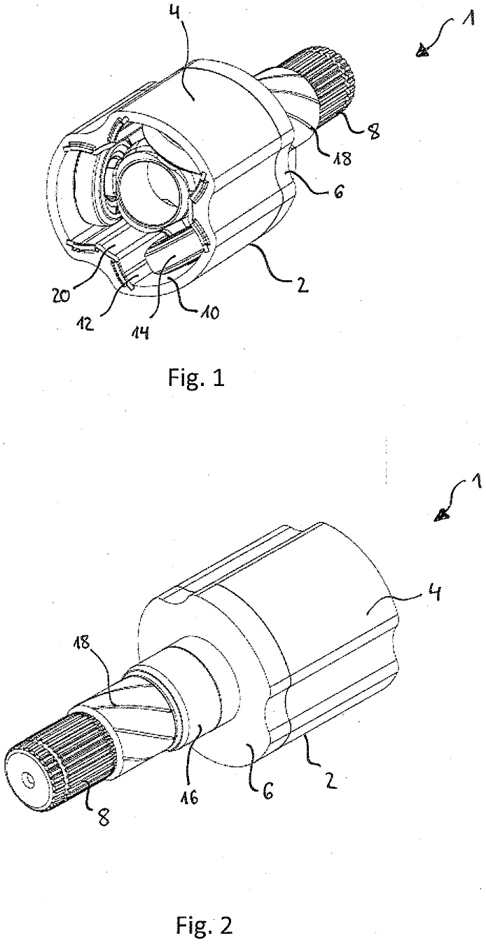

FIGS. 1 and 2 show a tripod joint 1 that can be used with a drive shaft (not shown). The tripod joint 1 includes a pot 2 that comprises a cylindrical housing part 4 and a base 6 formed with or connected to a shaft 8. In the form depicted here, the pot 2 has a tulip shape with internal pockets 10. Alternatively the pot 2 can have a tulip shape only in the interior, and be outwardly cylindrical. The base 6 and the housing part 4 can have the same outer circumference, as is depicted here, but this is not absolutely necessary.

In the pockets 10, raceways 12 are formed on which rollers 14 of the tripod joint 1 roll. For sealing the transmission housing, the a bottom of the base 6 forms a counter-surface for a seal ring of the transmission 16. Furthermore, ring grooves 18 are present on the shaft 8 in order to pump oil into the transmission.

In order to allow a simple and cost-effective manufacturing of the tripod joint 1, the tripod joint 1 proposed here is configured multi-part. This multi-part nature can on the one hand be realized by a housing 4 and a base 6 manufactured separately therefrom, and/or by raceway inserts 20 in a one-piece or multi-part housing part 4, which inserts 20 form the raceways 12. Both variants, which can also be realized in combination, are described in the following.

As described, the pot 2 can comprise the housing part 4 and the base 6 manufactured separately therefrom. These two elements 4, 6 can be connected in various ways, for example, by friction welding or pressing-in. This has the advantage that the housing part 4 can be manufactured in a simple manner, for example, from a cylindrical tube that is cut into corresponding lengths. These tube sections can then be shaped internally to form corresponding pockets 10 and subsequently connected to the base 6. As a result no aligning is required between the base 6 and the housing part 4, but rather the base 6 and the shaft 8 and the housing part 4 merely require the same axis. A precise orienting of the outer circumference of the base 6 with respect to the housing part 4 is not required.

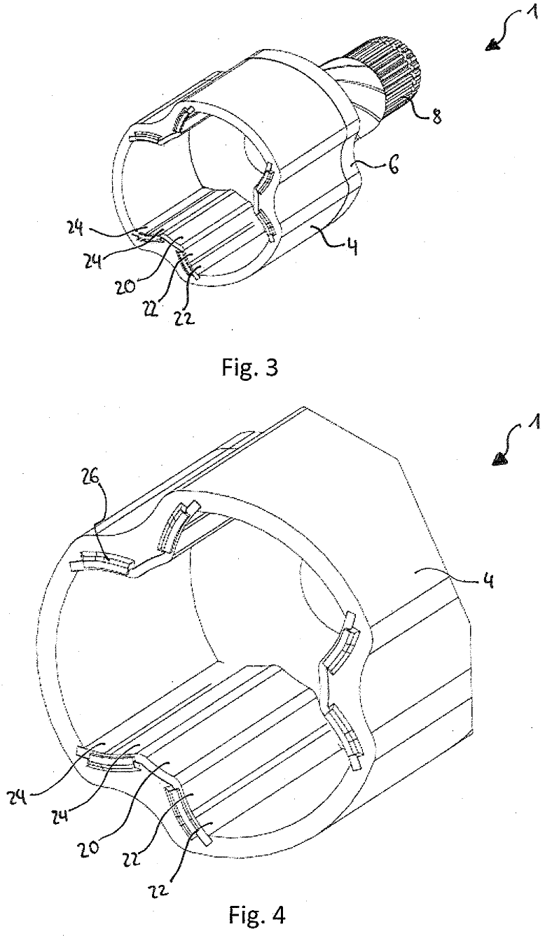

As already explained, the multi-part nature of the pot 2 can also be realized by inserts 20, which are shown in particular in FIGS. 3 and 4. These inserts 20 can be formed of steel, ceramic, or a similar hard material, in order to ensure the required hardness of the raceways 12. The housing part 4 itself can then also be manufactured from a softer material, such as, for example, aluminum. In the embodiment depicted here, the inserts 20 are configured such that they each provide a rolling surface 22, 24 for two different rollers. This means that a rolling surface 22, 24 is provided by two inserts 20 per roller 14. Alternatively it would also be possible to design the inserts 20 C-shaped such that each one insert 20 provides the rolling surfaces 22, 24 a single one roller 14.

The inserts 20 are attached in the housing part 4 by any type of connection, such as, for example, a flanging 26 as is used in the FIGS. 1-4 shown here. Alternatively the inserts 20 can also be welded to the housing part 4. A clamping between the inserts 20 and the housing part 4 has the advantage that the inserts 20 can be easily exchanged in the event of wear.

Due to the tripod joint proposed here, which is configured multi-part, a simple manufacturing is made possible that on the one hand is cost-effective, and on the other hand provides a stable and durable tripod joint.

Representative, non-limiting examples of the present invention were described above in detail with reference to the attached drawings. This detailed description is merely intended to teach a person of skill in the art further details for practicing preferred aspects of the present teachings and is not intended to limit the scope of the invention. Furthermore, each of the additional features and teachings disclosed above may be utilized separately or in conjunction with other features and teachings to provide improved tripod joints.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

REFERENCE NUMBER LIST

| | |
|---|---|
| 1 | Tripod joint |
| 2 | Pot |
| 4 | Housing part |
| 6 | Base |
| 8 | Shaft |
| 10 | Pocket |
| 12 | Raceway |
| 14 | Roller |
| 16 | Counter-surface |
| 18 | Ring groove |
| 20 | Insert |
| 22 | Rolling surface |
| 24 | Rolling surface |
| 26 | Flanging |

What is claimed is:

1. A tripod joint comprising:
a multi-part pot having an interior and a plurality of raceways for supporting a plurality of rollers in the interior.

2. The tripod joint according to claim 1, wherein the pot comprises a housing having an open end and a base opposite the open end.

3. The tripod joint according to claim 2,
including a shaft extending from an exterior surface of the base.

4. The tripod joint according to claim 3, where each of the raceways is formed on an interior surface of the housing.

5. The tripod joint according to claim 3,
wherein each the raceways comprises an insert mounted on an interior surface of the housing, and
wherein each of the raceways is formed from a material having a hardness greater than a hardness of a material of the housing.

6. The tripod joint according to claim 5,
wherein the inserts are formed from hardened steel and the housing is formed from aluminum.

7. The tripod joint according to claim 3,
wherein the base is formed separately from the housing and connected to the housing at a joint.

8. The tripod joint according to claim 7, where each of the raceways is formed on an interior surface of the housing.

9. The tripod joint according to claim 7,
wherein each the raceways comprises an insert mounted on an interior surface of the housing, and
wherein each of the raceways is formed from a material having a hardness greater than a hardness of a material of the housing.

10. The tripod joint according to claim 9,
wherein the inserts are formed from hardened steel and the housing is formed from aluminum.

11. The tripod joint according to claim 1,
wherein the pot comprises a housing having an interior and an open end, a base opposite the open end and a shaft attached to an exterior wall of the base and projecting away from the housing,
wherein the shaft has a longitudinal axis of rotation and extends in an axial direction,
wherein three channels are defined in an interior wall of the housing,
wherein each of the channels extends in the axial direction, faces into the housing interior, and has a pair of mutually facing side walls,
wherein each of the side walls is covered by a raceway insert connected to the housing, and
wherein each of the raceway inserts is formed from a material having a hardness greater than a material of the housing.

12. The tripod joint according to claim 11,
wherein each of the raceway inserts covers no more than one of the side walls.

13. The tripod joint according to claim 12,
wherein the base is formed separately from the housing and connected to the housing at a joint.

14. The tripod joint according to claim 11,
wherein each of the raceway inserts covers at least two of the side walls.

15. The tripod joint according to claim 14,
wherein the base is formed separately from the housing and connected to the housing at a joint.
